(19) United States
(12) Patent Application Publication
(10) Pub. No.: US 2015/0047295 A1
(43) Pub. Date: Feb. 19, 2015

(54) PUSHING DEVICE, TRANSPORT ARRANGEMENT AND PACKAGING ARRANGEMENT

(71) Applicant: Robert Bosch GmbH, Stuttgart (DE)

(72) Inventor: Heinrich van de Loecht, Muggensturm (DE)

(21) Appl. No.: 14/387,894

(22) PCT Filed: Feb. 14, 2013
(86) PCT No.: PCT/EP2013/052991

§ 371 Date: Sep. 25, 2014

(30) Foreign Application Priority Data
Mar. 29, 2012 (DE) 10 2012 205 060.4

(51) Int. Cl. B65B 35/20; B65G 37/00; B65B 5/04; B65G 47/76

(52) U.S. Cl. CPC B65B 35/205; B65G 47/766; B65G 37/00; B65B 5/04
USPC 53/235; 198/597

(57) ABSTRACT

The present invention relates to a pushing device (2) for pushing piece goods (4) from a conveying device (3) with a reliable process, comprising a circulating track (14) and at least one driven moving unit (10) which can be moved on the track (14), wherein the moving unit (10) comprises a paddle (11) for bearing against the piece good (4) arriving on the conveying device (3), and wherein the moving unit (10) comprises a slide (12) which can be displaced perpendicularly with respect to the moving direction (17) of the moving unit (10) in order to push the piece good (4) from the conveying device (3).

### BACKGROUND OF THE INVENTION

The present invention relates to a pushing device for pushing piece goods from a conveying device and a transport arrangement comprising a conveying device for transporting piece goods and the pushing device. In addition, the invention relates to a packaging arrangement comprising the transport arrangement and to a method for pushing piece goods from a conveying device.

In packaging arrangements, in particular cartoning machines, the products are in each case initially received on a transport system from a pair of cell angles and fed continuously or in a stepwise manner to the actual cartoning process. The pushing or, respectively, leading cell angles are connected respectively to two roller chains and can thereby be manually adjusted to the corresponding product width by displacing the chains relative to one another. In so doing, the products are received by respectively one pair of cell angles. In conventional cartoning machines, a so-called folding box chain that is connected in parallel with the product chain and runs synchronously with the same is provided as a carrier for the folding boxes and for supporting the process of setting the boxes upright. The following insertion systems are typically used in cartoning machines for transferring products into the open folding boxes: a drum insertion device comprising circumferential insertion elements that operate synchronously with the product chain is known. The insertion elements have a fixed spacing distance and are axially displaced via switching points in a path-dependent manner. In addition, a reversing linear motion of a plurality of insertion elements, which have alternating synchronous running and counter-rotation phases, parallel to the product chain is known. In a third option, two- or multi-chain systems, which are driven by servomotors and comprise insertion elements that can be driven in opposite directions, are used in parallel with the product chain. The cartoning machines known from the prior art have, in particular, the following disadvantages: Product chains that are a plurality of meters in length are always required, which constitutes a significant cost factor. In addition, a manual adjustment of the product cell angle to the packaged good width is required with such machines. Furthermore, insertion problems are always possible when transferring the product into the folding box. This results from the fact that a relatively large amount of play is required between the cell angles of the product chain and the product in order to ensure a product feed that can be reliably executed.

### SUMMARY OF THE INVENTION

In contrast to the devices from the prior art, the inventive pushing device facilitates a cost efficient and reliable pushing of piece goods from a conveying device. An automated adjustment of the entire product chain to the width of the piece good takes place with said device. The product can be received in a play-free manner, whereby a discharge of the piece good with a reliable process or a transfer of the piece good into a folding box with a reliable process is possible. In comparison to the conventional devices, the pushing device according to the invention comprises substantially fewer moving masses. Higher clock frequencies in the clocked operation are possible and a gentle product handling results. All of these advantages are achieved by a pushing device for pushing piece goods from a conveying device, comprising a circulating track and at least one driven moving unit which can be moved on the track. The moving unit is movable with respect to the track and can be moved to any desired position on the track. The moving unit comprises a paddle and a slide. The paddle and the slide are fixedly mounted to a chassis frame of the moving unit and therefore move with the entire moving unit. The paddle is designed for bearing against the piece good arriving on the conveying device. The slide can be displaced perpendicularly with respect to the moving direction of the moving unit. As a result, the piece good can be pushed with the slide from conveying device. The piece goods can thereby be intermittently or continually fed with the conveying device. Said conveying device relates particularly to a linear conveying device, for example a conveyor belt or a circulating chain or a circulating belt.

Provision is made in a preferred embodiment for the moving unit to comprise at least one permanent magnet and for individually actuated solenoids for driving the moving unit to be disposed along the track. Said individually actuated solenoids generate a so-called moving electromagnetic field and constitute a part of the linear drive for the moving units. Depending on whether current is passed through the solenoids, a corresponding electromagnetic field is generated and a magnetic coupling between solenoid and moving unit is produced. As a result, the moving unit can be positioned at any desired position on the track. In particular, a position detection system is provided on the pushing device, said system detecting the current position of the moving unit on the track.

In a particularly preferred embodiment, the paddle can be displaced perpendicularly with respect to the moving direction of the moving unit. It is thereby possible to position the pushing device directly adjacent to the conveying device. In so doing, the paddles are channeled between the cell angles on the conveying device. To this end, the paddles are initially retracted perpendicularly to the moving direction of the moving unit and then inserted between the cell angles.

Provision is particularly made for preferably at least two moving units to be disposed on the track. In so doing, each moving unit can be individually actuated; thus enabling a position of the moving unit on the track and a distance between adjacent moving units to be changed. This is especially possible due to the moving electromagnetic field and the position detection system.

In addition, provision is preferably made for a detection unit for detecting a position of the piece good arriving on the conveying device. By means of this detection unit, the pushing device detects the position of the incoming piece good and can bring one of the moving units into position. In so doing, the moving unit is brought into position in such a way that the paddle bears against one side of the piece good.

The invention further comprises a transport arrangement comprising a conveying device for conveying piece goods and the pushing device as previously described. The conveying device comprises at least one cell angle. In particular, the conveying device comprises a plurality of cell angles that are spaced apart from one another, one of the pieces goods being disposed in each case between two cell angles. According to the invention, the distance between the cell angles no longer has to be matched to the width of the piece good. A first side of the piece good arriving on the conveying device abuts against one of the cell angles and the moving unit is controlled such that the paddle bears against the side of the piece good that lies opposite the first side. As a result, a secured position of the piece good is established and the slide can push the piece good from the conveying device in a defined manner.

Provision is preferably made for the moving direction of the moving unit and the direction of movement of the conveying device to lie in planes parallel to one another. The track has, in particular, an oval shape, the two longer sides of the oval being parallel to the conveying device, in particular parallel to a conveyor belt.

The advantageous embodiments described within the scope of the inventive pushing device can correspondingly be advantageously applied to the transport arrangement according to the invention.

The invention further comprises a packaging arrangement comprising one of the previously described transport arrangements and a providing means. Situated next to the conveying device, the providing means is designed for providing a packaging, in particular a folding box. The slide is designed to push the piece good from the conveying device and at the same time to insert said piece good into the packaging. The packaging arrangement relates particularly to a cartoning machine for the packaging of pharmaceutical or cosmetic products or for food products. The one cell angle on the conveying device and the paddles of the moving unit define the exact position of the piece good; thus enabling the piece good to be exactly inserted into the packaging by means of the slide.

The advantageous embodiments described within the scope of the inventive pushing device and the transport arrangement can correspondingly be advantageously applied to the packaging arrangement according to the invention.

The invention further comprises a method for pushing piece goods from a conveying device. The method comprises the following steps: (i) detecting a position of the incoming piece good on the conveying device, (ii) moving a moving unit on a circulating track so that a paddle of the moving unit bears against the piece good, and (iii) pushing the piece good from the conveying device with a slide of the moving unit. Provision is particularly made for the moving unit to be moved at the same speed as the conveying device after the paddle has come into abutment with the piece good. As a result, the moving unit moves synchronously with the piece good being conveyed on the conveying device. When the piece good is being packaged, an open packaging is moved parallel to the conveying device likewise at the same speed; thus enabling the piece good to be packaged as said piece good advances on the conveying device.

The advantageous embodiments described within the scope of the inventive pushing device, transportation arrangement or packaging arrangement can correspondingly be advantageously applied to the method according to the invention.

### BRIEF DESCRIPTION OF THE DRAWINGS

An exemplary embodiment of the invention is described below in detail with reference to the accompanying drawings. In the drawings:

FIG. 1 shows an inventive transport arrangement according to one exemplary embodiment;

FIG. 2 shows an inventive pushing device of the inventive transport arrangement according to the exemplary embodiment; and

FIG. 3 shows a conveying device of the inventive transport arrangement according to the exemplary embodiment.

### DETAILED DESCRIPTION

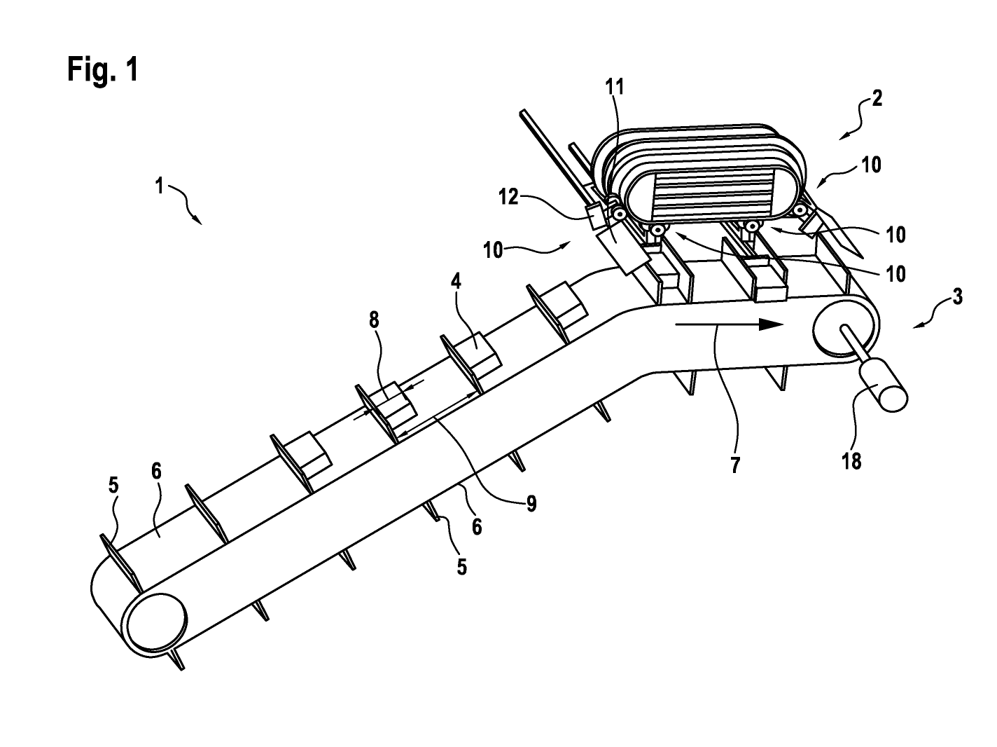

FIG. 1 shows a transport arrangement 1 pursuant to the exemplary embodiment. The transport arrangement 1 comprises a pushing device 2 and a conveying device 3 for conveying piece goods 4.

The conveying device 3 is composed of a belt 6 and a plurality of cell angles 5 protruding perpendicularly from the belt 6. The conveying device 3 is circulated in the indicated direction of movement 7.

A piece good 4 is located in each case between two cell angles 5. One side of the piece good 4 abuts against a cell angle 5. This is referred to as a pushing cell angle 5. In order to ensure that the piece good 4 reliably abuts against the pushing cell angle 5, the conveying device 3 is partially set at an angle greater than 0 degrees. In order to support the abutment process, a longitudinal vibration comprising correspondingly adapted acceleration ramps can be imposed on the belt 6 via a servo drive.

FIG. 1 furthermore shows a distance 9 between two adjacent cell angles 5 and a length 8 of the piece good 4. According to the invention, the distance 9 between the cell angles 5 no longer has to be adjusted because the pushing device 2 reacts resiliently to the length 8 of the piece good 4. Provision is therefore preferably made for the distance 9 to be greater than the length 8.

The pushing device 2 comprises a plurality of moving units 10. Each of these moving units 10 comprises a paddle 11 and a slide 12. The pushing device 2 detects the position or the size of the incoming piece good 4. A moving unit 10 is then moved such that the paddle 10 as a leading cell angle bears against the piece good 4. As a result, the position of the piece good 4 is defined and said piece good 4 can be pushed from the conveying device 3 via the slide 11. In particular, a providing means is located next to the conveying device 3, a packaging, in particular a carton, being situated on said providing means. The piece good 4 is thereby pushed directly from the conveying device 3 into the packaging.

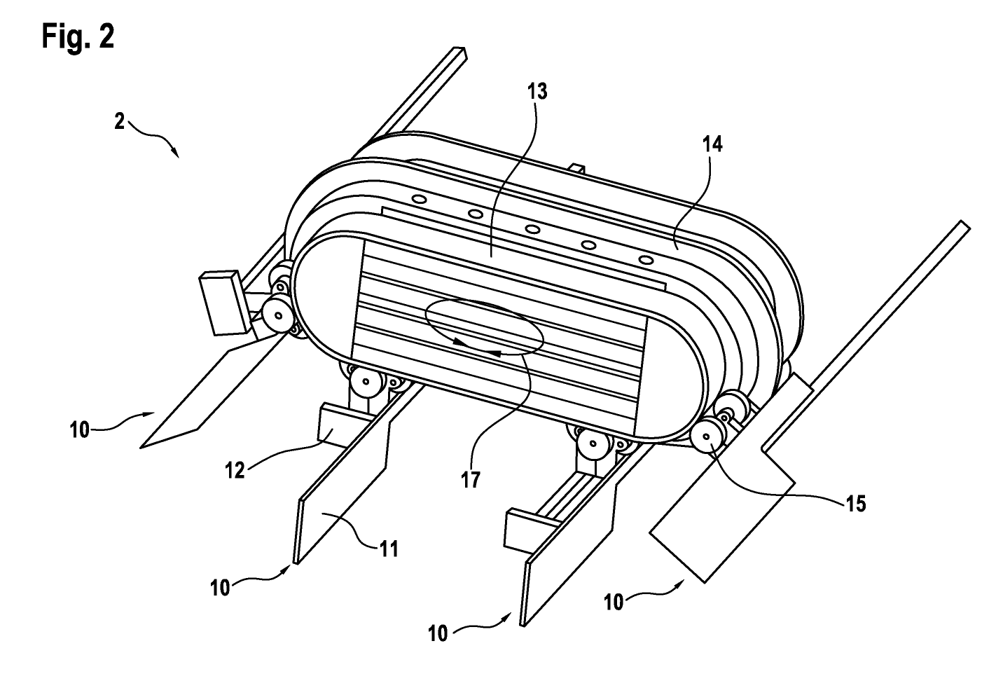

FIG. 2 shows the pushing device 1 in detail. Pursuant to this depiction, the pushing device 2 comprises a base frame 13. Said base frame 13 has an oval shape. A circulating track 14 consisting of guide rails fixed to the base frame is situated on said base frame 13. The track 14 constitutes a guideway for the moving units 10. The moving units 10 have respectively a plurality of rollers 15. The moving units 10 are guided on the track 14 by means of said rollers 15. The paddles 11 and slides 12 move in each case together with the respective moving unit 10.

The moving units 10 can therefore be positioned and moved arbitrarily on the track along the designated moving direction 17. In particular, a plurality of the solenoids that can be individually actuated is disposed in the base frame 13. A so-called moving electromagnetic field can be generated via said solenoids. The moving units 10 each comprise a permanent magnet; thus enabling said moving units 10 to be positioned and moved via said moving electromagnetic field.

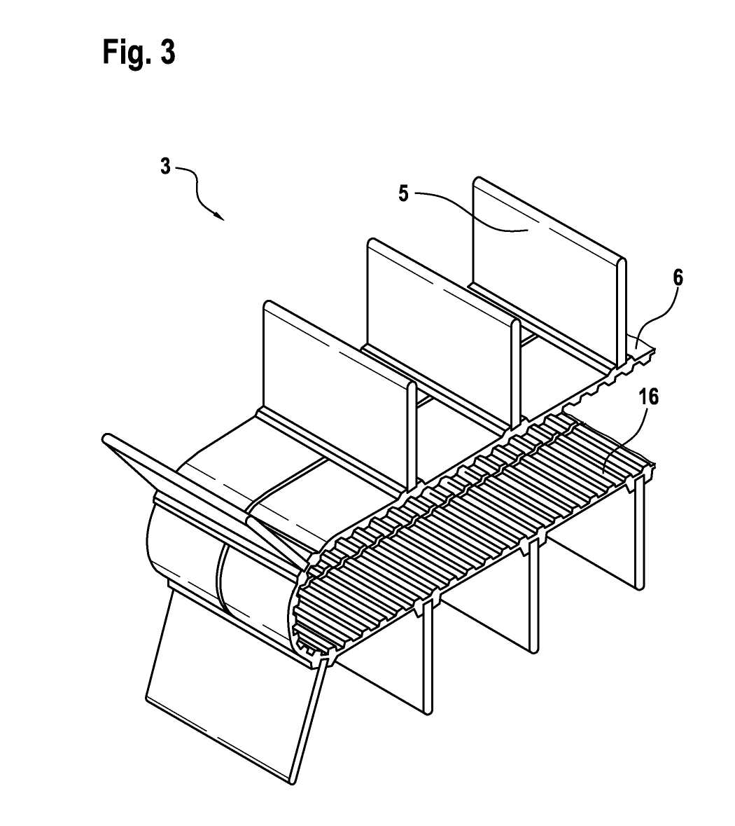

FIG. 3 shows in detail a cutout of the conveying device 3. It can be seen here that the individual cell angles 5 are fixedly fastened to the belt 6. A tooth system 16 for driving the conveying device 3 is configured on the inner side of the belt 6. The belt of the conveying device 3 comprises, in particular, mounting cams, between which the cell angles 5 can be inserted. In so doing, a highly resilient and, in particular, flexurally rigid coupling between the cell angles 5 and the belt 6 results in the linear as well as in the deflection region.

According to this exemplary embodiment, The pushing device 2 is disposed as an “overhead runner” laterally beside the conveying device 3. The cell angles 5 act only in a pushing manner on the piece good 4. When the piece good 4 enters into the working area of the pushing device 2, for example when passing through a light barrier, a trigger signal is generated for the control system. Subsequently thereto, the moving units 10 are synchronized to the front edge of the piece good 4 and the paddle is brought into abutment with the piece good 4. The moving units can also alternatively be synchronized by means of a drive 18 of the conveyor belt 6. The drive 18 is preferably designed as a belt drive comprising an integrated angle measuring system. Immediately thereafter, the piece good 4, as a result of a corresponding relative movement, can be received free of play between the pushing cell angle 5 and the paddle 11. As a result, the requirements for pushing the piece good from the conveying device with the slide 11 or the insertion of said piece good into a packaging are met.

The slides 12 are provided for pushing or transferring piece goods from the conveying device. Said slides 12 can comprise passive drive elements, e.g. guide switch points; thus enabling said slides to be displaced, relative to the remaining moving units 10, perpendicularly to the direction of travel 17. It is however also possible to directly equip the slides 12 with permanent magnets. In addition, a moving electromagnetic field is required for moving the permanent magnets and the slide 12 perpendicularly to the moving direction 17.

1. A pushing device (2) for pushing piece goods (4) from a conveying device (3), comprising:
a circulating track (14), and
at least one driven moving unit (10) configured to be moved on the track (14),
wherein the moving unit (10) comprises a paddle (11) for bearing against a piece good (4) arriving on the conveying device (3), and
wherein the moving unit (10) comprises a slide (12) configured to be displaced perpendiculary with respect to a moving direction (17) of the moving unit (10) in order to push the piece good (4) from the conveying device (3).

2. The pushing device according to claim 1, characterized in that the moving unit (10) comprises at least one permanent magnet, and wherein solenoids for driving the moving unit (10) are disposed along the track (14), the solenoids being configured to be individually actuated.

3. The pushing device according to claim 1, characterized in that the paddle (11) can be displaced perpendicularly with respect to a moving direction (17) of the moving unit (10).

4. The pushing device according to claim 1, characterized by a plurality of driven moving units (10) configured to be moved on the track (14), wherein each of the moving units is configured to be individually actuated so that a position of the moving unit (10) on the track and a distance between adjacent moving units (10) can be changed.

5. The pushing device according to claim 1, characterized by a detection unit for detecting a position of the piece good (4) arriving on the conveying device (3).

6. A transport arrangement (1) comprising a conveying device (3) for transporting piece goods (4) and a pushing device (2) according to claim 1 for pushing a piece good (4) from the conveying device (3), the conveying device (3) comprising at least one cell angle (5) for bearing against a first side of the piece good (4) and the paddle (11) being configured to bear against a second side of the piece good (4) which is opposite the first side.

7. The transport arrangement according to claim 6, characterized in that a moving direction (17) of the moving unit and a direction of movement (7) of the conveying device (3) lie in planes that are parallel to one another.

8. A packaging arrangement comprising a transport arrangement (1) according to claim 6 and a providing means situated next to the conveying device (3) for providing a packaging, wherein the slide (12) is configured for pushing the piece good (4) from the conveying device (3) and for simultaneously inserting said piece good (4) into the packaging.

9. A method for pushing piece goods (4) from a conveying device (3), comprising the following steps:
detecting a position of a piece good (4) arriving on the conveying device (3),
moving a moving unit (10) on a circulating track (14) so that a paddle (11) of the moving unit (10) bears against the piece good (4), and
pushing the piece good (4) from the conveying device with a slide (12) of the moving unit (10).

10. The method according to claim 9, characterized in that the moving unit (10) is moved at the same speed as the conveying device (3) after the paddle (11) has come into abutment with the piece good (4).

11. The pushing device according to claim 2, characterized in that the paddle (11) can be displaced perpendicularly with respect to a moving direction (17) of the moving unit (10).

12. The pushing device according to claim 11, characterized by a plurality of driven moving units (10) configured to be moved on the track (14), wherein each of the moving units is configured to be individually actuated so that a position of the moving unit (10) on the track and a distance between adjacent moving units (10) can be changed.

13. The pushing device according to claim 12, characterized by a detection unit for detecting a position of the piece good (4) arriving on the conveying device (3).
